(19) United States
(12) Patent Application Publication
(10) Pub. No.: US 2006/0252008 A1
(43) Pub. Date: Nov. 9, 2006

(54) Dental insertion element of non-cylindrical shape

(76) Inventor: Barbara Muller, (US)

Correspondence Address: Ronald S Santucci;Formmer Lawrence & Haug, 745 fifth Avenue, New York, NY, 10151, US

(21) Appl. No.: 10/564,576

(22) PCT Filed: Jul. 21, 2004
(86) PCT No.: PCT/EP04/08178

§ 371 Date: May 11, 2006

(30) Foreign Application Priority Data
Jul. 22, 2003 (DE) 10333455.6

(51) Int. Cl. A61C 5/14

(52) U.S. Cl. 433/136

(57) ABSTRACT

The present invention relates to a dental insertion element for use in the oral cavity, which insertion element is characterised in that it has a cross-sectional area having a non-circular periphery.

The general area of the present invention is that of dentistry accessories, the invention relating to a dental insertion element of non-cylindrical shape for use in the oral cavity.

In dentistry interventions, for example root treatment or cavity treatment, it is of substantial importance to the success of the treatment that the treatment area inside the mouth of the patient be kept clean and dry. The properties of a large number of materials used for treatment purposes in the dental sector can disadvantageously be substantially impaired as a result of undesirable contact with aqueous substances, for example saliva or blood. Infections can, moreover, be caused by such contact.

An often used possibility for solving that problem consists, for example, of applying a stretched rubber dam. In that case, the area surrounding the treatment region is covered over by means of a stretched rubber sheet provided with a hole. However, in some patients, allergic reactions can occur when a stretched rubber dam is used.

More quickly applied and far more comfortable for the patient is the known use of dental insertion elements, for example wadding rolls made from cotton. Manufacture of wadding rolls of such a kind known in the prior art is simple. Usually, for that purpose, for example, a layer of non-woven cotton is rolled up in a spiral and then, using a suitable adhesive, bonding is carried out on the outside. The wadding rolls are then cut to the desired length.

In addition to their property of absorbing liquids, wadding rolls are suitable for separating, from one another, the oral mucosa and/or tongue and the tooth area that is being treated, this spacer function being assigned an especially important role because nowadays liquids in the oral cavity during treatment are regularly aspirated by specific suction devices.

However, it has been found that customary wadding rolls, which, for example, are wedged between the mucosa of the cheek and the teeth, can easily slip, in particular roll out, as a result of which the mucosa of the cheek can undesirably come into contact with those locations from which it should be kept separate for the above-mentioned reasons. Furthermore, the spacer function is frequently inadequate as a result of the small diameter of the wadding rolls, especially as the wadding rolls deform into an oval when wetted through and subjected to pressure.

It has furthermore been found to be disadvantageous that in certain applications, for example during conventional teeth bleaching in the case of discoloured teeth, wadding rolls are suitable only to a limited extent because it is not possible to ensure that locations which should not come into contact with bleaching agent are covered over completely.

Wadding rolls furthermore have the disadvantage of only limited stackability during storage.

The problem of the present invention is accordingly to provide a dental insertion element which can be reliably positioned in the oral cavity, without having to fear that it will slip, and by means of which an improved spacer function can be achieved compared to the conventional wadding rolls. Furthermore, a dental insertion element of such a kind should preferably be capable of ensuring that particular regions of the oral cavity and/or teeth are covered over almost completely, in order to allow the use of a dental insertion element of such a kind in particular dentistry activities, for example the bleaching of discoloured teeth. Not least, the storage, especially stackability, of a dental insertion element of such a kind should be improved in comparison to the conventional wadding rolls.

The problem is solved, in accordance with the invention, by means of the independent claim. Advantageous embodiments of the invention are mentioned in the subordinate claims.

In accordance with the invention, a dental insertion element is provided for use in the oral cavity, which insertion element is characterised in that it has a cross-sectional area, especially when cut perpendicular to the longitudinal direction, having a generally non-circular periphery. The dental insertion element in accordance with the invention accordingly differs in its three-dimensional shape from the conventional cylindrical wadding roll and can, in general terms, have any desired non-cylindrical three-dimensional shape.

In an especially advantageous embodiment of the present invention, the dental insertion element has a cross-sectional area, especially when cut perpendicular to the longitudinal direction, which has a periphery in the shape of a first part-circle, having a first radius of curvature, the end-points of which are joined by at least one curved line.

The three-dimensional shape of the dental insertion element of that embodiment accordingly comprises, corresponding to the first part-circle seen in cross-section, a part-cylinder cut along the cylinder axis, which then passes into a curved portion of any shape corresponding to the at least one curved line seen in cross-section.

In that case, it is advantageous for the curved line joining the end-points of the first part-circle, when seen in cross-section relative to the longitudinal direction, to be in the shape of a second part-circle, the radius of curvature of the first part-circle being smaller than the radius of curvature of the second part-circle. From that it follows that the three-dimensional shape of that embodiment of the dental insertion element is composed of two part-cylinders cut along the cylinder axis, which have different cylinder radii. In that case, it has been found to be especially advantageous for the radius of curvature of the second part-circle to be substantially larger than the radius of the first part-circle, that is to say for the part-cylinder belonging to the second part-circle to be substantially less curved than the part-cylinder belonging to the first part-circle.

In a further, especially advantageous embodiment of the dental insertion element according to the invention, the cross-sectional area cut perpendicular to the longitudinal direction has a periphery in the shape of a first part-circle the end-points of which are joined by at least one at least approximately straight line. From that it follows that the three-dimensional shape of the dental insertion element is composed of a part-cylinder cut along the cylinder axis, which passes into one or more approximately flat surfaces.

In the above-mentioned embodiments according to the invention it is especially advantageous for the curved or at least approximately straight line joining the end-points of the first part-circle at the geometric periphery of the cross-sectional area to pass into the first part-circle in a not continuously differentiable manner at least in a mathematical idealisation. This means that, where the part-cylinder cut along the cylinder axis passes into the curved portion or into the at least one flat surface, the three-dimensional shape of the dental insertion element has an edge.

In a further preferred embodiment of the dental insertion element according to the invention, the cross-sectional area cut perpendicular to the longitudinal direction has a geometric periphery in the shape of a closed polygonal figure. The geometric periphery of the cross-sectional area can especially be in the shape of an oval, a honeycomb structure, a rectangle or a triangle.

It is furthermore advantageous for the dental insertion element according to the invention to have a curved three-dimensional shape. Likewise it can be advantageous for the dental insertion element according to the invention to be provided with a three-dimensional shape that becomes narrower in the longitudinal direction.

In a further preferred embodiment of the dental insertion element, it is, in a first sectional plane, which, for example, corresponds to a plan view of the dental insertion element, substantially V-shaped. With the aid of a dental insertion element shaped in such a way, displacement of the tongue can be achieved in especially advantageous manner after the insertion element has been placed in the mouth, so that space is created for the dentist to perform treatment. In that respect it is additionally advantageous for such a dental insertion element to be substantially wedge-shaped in a second sectional plane perpendicular to the first sectional plane.

A dental insertion element of such a kind can be formed from one layer or, especially, from a multi-layer composite material, in which case it is advantageous for the covering layers of the composite material to include or consist of an absorbent material. For that purpose, the composite material can be composed of a core layer and at least one, preferably two, covering layers surrounding the core layer, in which case the core material can consist of, or includes, at least one material selected from silicone, natural fibres, synthetic fibres and plastics, especially polyethylene, polyamide or polypropylene, and, optionally, customary additives, whereas the covering layers independently of one another can consist of, or include, at least one material selected from absorbent natural fibres and absorbent synthetic fibres, such as wadding, especially cotton-wool wadding, and, optionally, customary additives. Preference is given to a dental insertion element having a core layer and two covering layers. The covering layers can be applied in a manner that is customary per se, for example by bonding on the core layer. When the dental insertion element according to the invention has only one layer, that layer can include, or consist of, one of, or any desired combination of two or more of, the afore-mentioned materials.

In a further, especially advantageous embodiment of the dental insertion element according to the invention, it has at least one surface which is matched to particular anatomical features in the oral cavity. Accordingly, at least one surface of the dental insertion element can be matched to the contour of a tooth or a plurality of teeth. Likewise, the surface can be matched to the tongue and/or the inner wall of the oral cavity, for example the palate. By that means, especially in conjunction with a three-dimensional shape that is curved and/or that narrows in the longitudinal direction, a dental insertion element that is “tailored” to anatomical features can be produced.

In the case of all the above-mentioned preferred embodiments of the dental insertion element according to the invention, which can, as desired, be present alone or in combination, it is possible to reduce the risk of slippage, especially rolling-out, of the non-cylindrical dental insertion element positioned in the oral cavity, for example wedged in between the oral mucosa and teeth. This is especially true of those embodiments whose three-dimensional shape includes edges. As a result of the dental insertion element according to the invention, the spacer function can, moreover, be considerably improved because the ratio of the lateral end-to-end spacing of the dental insertion element in relation to its volume can be increased in comparison to the conventional cylindrical wadding roll. This is especially true of those embodiments which have a three-dimensional shape in the form of a part-cylinder which passes into a less curved part-cylinder or into at least one flat surface, and also of that embodiment which in a first sectional plane is substantially V-shaped.

Storage, that is to say stackability, is improved to a particular degree in the case of those embodiments whose three-dimensional shape is provided with at least one at least approximately flat surface. The same is true when the three-dimensional shape is in the form of a part-cylinder which passes into a substantially less curved part-cylinder.

For the covering function of the dental insertion element, those embodiments whose three-dimensional shape is provided with at least one at least approximately flat surface are especially advantageous. The same is true when the three-dimensional shape is in the form of a part-cylinder which passes into a substantially less curved part-cylinder. In this context, that embodiment which has at least one surface which is matched to the contour of anatomical features in the oral cavity is to be considered especially advantageous.

Furthermore, the dental insertion element according to the invention can, advantageously, be so formed that the dental insertion element can be prevented to a very large extent from adhering to anatomical structures of the oral cavity.

The invention furthermore relates to an endless strand from which the dental insertion element according to the invention can be cut to a desired length.

The invention is described below in greater detail with reference to exemplary embodiments with reference to the accompanying drawings, in which:

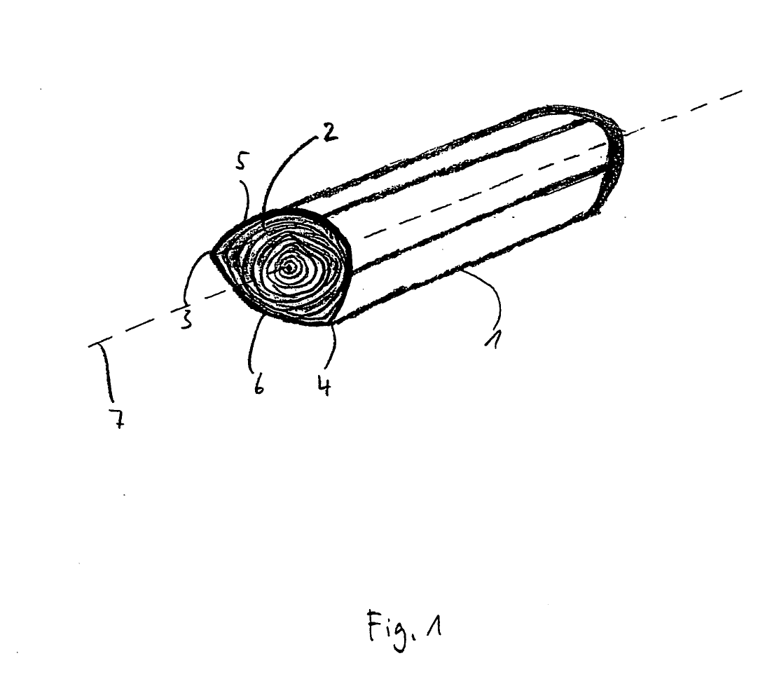

FIG. 1 shows, in a perspective view, an embodiment of the dental insertion element according to the invention;

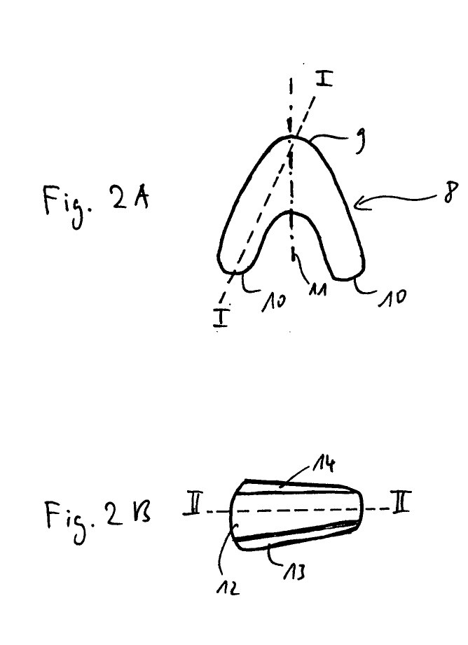

FIGS. 2A and 2B show a further embodiment of the dental insertion element according to the invention, FIG. 2A being a sectional view according to the line II-II of FIG. 2B, and FIG. 2B being a sectional view according to the line I-I of FIG. 2A.

FIG. 1 shows a first embodiment of the dental insertion element 1 according to the invention, which is made from cotton-wool wadding. The dental insertion element 1 is provided in the form of a longitudinal profile part, the longitudinal direction being defined by the longitudinal axis 7. The cross-sectional area 2 of the longitudinal profile part, when cut perpendicular to the longitudinal axis, has a geometric periphery which is composed of a first circle-line 5 and a second circle-line 6, the second circle-line 6 having a substantially larger radius of curvature than the first circle-line 5.

In each case, the two circle-lines 5, 6 pass into one another at a ridge location 3, 4. In the three-dimensional shape, the dental insertion element is composed of two part-cylinders cut parallel to their respective cylinder axes, corresponding to the first and second circle-lines 5, 6. In the three-dimensional shape, the joins between the first and second circle-lines 5, 6, in the form of the ridges 3, 4, correspond, in each case, to edges on the external surface of the dental insertion element.

The dental insertion element shown in FIG. 1 can be simply produced by rolling and bonding a layer of cotton-wool wadding and subsequently compressing the wadding roll for the purpose of providing the dental insertion element with the shape as stated. Likewise, the dental insertion element can be produced in the form of an endless strand which is deformed in a manner according to the invention by means of suitable shaping systems such as triangular dies and further shaping aids and then covered with a nonwoven fabric for the purpose of dimensional stability.

FIGS. 2A and 2B show a further embodiment of the dental insertion element according to the invention, FIG. 2A corresponding to a sectional view according to line II-II of FIG. 2B, whereas FIG. 2B corresponds to a sectional view according to line I-I of FIG. 2A. As can be seen from FIG. 2A, the dental insertion element 8 is, in the plan view corresponding to a first sectional plane (II-II), substantially V-shaped. In a sectional plane (I-I) perpendicular to the first sectional plane, the dental insertion element is wedge-shaped. As can be seen from FIG. 2A, the substantially V-shaped form of the dental insertion element 8 is produced from a tip portion 9 and two arm portions 10. The dental insertion element is symmetrically shaped with respect to a central plane 11. As can be seen from FIG. 2B, the dental insertion element is formed from a multi-layer composite material, the composite material being composed of a wedge-shaped core layer 12 of silicone and absorbent covering layers 13 and 14 of viscose and cotton surrounding the core layer 12. The covering layers 13 and 14 are bonded onto the core layer 12 by means of a suitable adhesive. The embodiment of the dental insertion element shown in FIGS. 2A and 2B is especially suitable for being placed underneath the tongue in order to displace the tongue upwards and create space for the dentist to perform treatment.

1. Dental insertion element for use in the oral cavity, wherein it has a cross-sectional area having a non-circular periphery.

2. Dental insertion element according to claim 1, wherein it has a cross-sectional area having a periphery in the shape of a first part-circle, having a first radius of curvature, the end-points of which are joined by at least one curved line.

3. Dental insertion element according to claim 2, wherein the curved line joining the end-points of the first part-circle is in the shape of a second part-circle, the radius of curvature of the first part-circle being smaller than the radius of curvature of the second part-circle.

4. Dental insertion element according to claim 1, wherein it has a cross-sectional area having a periphery in the shape of a first part-circle the end-points of which are joined by at least one at least approximately straight line.

5. Dental insertion element according to claim 2, wherein the line joining the end-points of the first part-circle passes into the first part-circle in an at least approximately not continuously differentiable manner.

6. Dental insertion element according to claim 1, wherein it has a cross-sectional area having a periphery in the shape of a closed polygonal figure.

7. Dental insertion element according to claim 6, wherein the periphery of the cross-sectional area has a honeycomb structure.

8. Dental insertion element according to claim 6, wherein the periphery of the cross-sectional area has a rectangular shape.

9. Dental insertion element according to claim 6, wherein the periphery of the cross-sectional area has a triangular shape.

10. Dental insertion element according to claim 1, wherein it has a three-dimensional shape that becomes narrower in the longitudinal direction.

11. Dental insertion element according to claim 1, wherein it is produced from wadding.

12. Dental insertion element according to claim 1, wherein it is in the shape of a longitudinal profile part.

13. Dental insertion element according to claim 1, wherein the cross-sectional area is the cross-sectional area cut perpendicular to the longitudinal direction.

14. Dental insertion element according to claim 1, wherein it has no cross-sectional area having a circular periphery.

15. Dental insertion element according to claim 1, wherein it has a straight or curved three-dimensional shape.

16. Dental insertion element according to claim 10, wherein, in a first sectional plane, it is substantially V-shaped.

17. Dental insertion element according to claim 16, wherein, in a second sectional plane perpendicular to the first sectional plane, it is substantially wedge-shaped.

18. Dental insertion element according to claim 16, wherein it is formed from one material component, preferably a foamed material, or from a plurality of material components, preferably synthetic fibre or natural fibre, optionally combined with highly absorbent material.

19. Dental insertion element according to claim 18, wherein it is formed from a multi-layer composite material.

20. Dental insertion element according to claim 19, wherein the composite material is composed of a core layer and covering layers surrounding the core layer.

21. Dental insertion element according to claim 19, wherein the core material is selected from at least one material from the group consisting of silicone, natural fibres, synthetic fibres and plastics, especially polyethylene, polyamide or polypropylene, and, optionally, customary additives, it being possible for the core material to be absorbent or highly absorbent, whereas the covering layers independently of one another are selected from at least one material from the group consisting of optionally absorbent natural fibres and optionally absorbent synthetic fibres and, optionally, customary additives, the covering layers being permeable to moisture and not impeding the transport of moisture from the outside to the interior of the insertion element.

22. Dental insertion element according to claim 1, wherein it has at least one surface which is matched to anatomical features in the oral cavity, especially to the contour of one or more teeth, to the contour of the tongue, or to the contour of the inner wall of the oral cavity such as the upper or lower palate region.

23. Endless strand comprising a multiplicity of dental insertion elements according to claim 1.
